(19) United States
(12) Patent Application Publication
(10) Pub. No.: US 2026/0100364 A1
(43) Pub. Date: Apr. 9, 2026

(54) POSITIVE ELECTRODE ACTIVE MATERIAL AND LITHIUM ION SECONDARY BATTERY

(71) Applicant: TOYOTA JIDOSHA KABUSHIKI KAISHA, Toyota-shi (JP)

(72) Inventors: Momoko PROCTER, Seto-shi (JP); Yuji MAHARA, Seto-shi (JP); Taku KINOSHITA, Toyota-shi (JP)

(73) Assignee: TOYOTA JIDOSHA KABUSHIKI KAISHA, Toyota-shi (JP)

(21) Appl. No.: 19/335,501

(22) Filed: Sep. 22, 2025

(30) Foreign Application Priority Data
Oct. 3, 2024 (JP) 2024-174241

(51) Int. Cl. H01M 4/525; C01G 53/502; H01M 4/36; H01M 10/0525

(52) U.S. Cl. CPC H01M 4/525; C01G 53/502; H01M 4/366; H01M 10/0525; C01P 2002/50; C01P 2004/50; C01P 2004/61; C01P 2004/62; C01P 2006/40

(57) ABSTRACT

The positive electrode active material includes single crystal particles and polycrystalline particles, the polycrystalline particles are formed by associating a plurality of the single crystal particles, each of the single crystal particles and the polycrystalline particles includes a lithium nickel composite oxide having a layered structure, and the single crystal particles satisfy all relationships of the following formulas (1) to (3). In the formulas (1) to (3), D10, D50 and D90 each represent a particle diameter having an integrated value of 10%, a particle diameter having an integrated value of 50%, and a particle diameter having an integrated value of 90% in a volume-based particle size distribution of the single crystal particles, and D10, D50 and D90 each have units of micrometers.

$$D 10 \leq 2.5 \qquad ( 1 )$$

$$D 50 \leq 5. \qquad ( 2 )$$

$$( D 90 - D 10 ) / D 50 \geq 3. \qquad ( 3 )$$

### CROSS-REFERENCE TO RELATED APPLICATION

This application claims priority to Japanese Patent Application No. 2024-174241 filed on Oct. 3, 2024. The disclosure of the above-identified application, including the specification, drawings, and claims, is incorporated by reference herein in its entirety.

### BACKGROUND

### 1. Technical Field

The present disclosure relates to a positive electrode active material and a lithium ion secondary battery.

### 2. Description of Related Art

Japanese Unexamined Patent Application Publication No. 2023-36062 (JP 2023-36062 A) discloses a positive electrode active material that is a metal oxide containing single crystal particles having a particle diameter of 1 to 8 μm and has a predetermined particle size distribution.

### SUMMARY

The positive electrode active material of JP 2023-36062 A has a narrow particle size distribution, and when the density of the positive electrode active material layer is increased by pressing, the frequency of contact between the positive electrode active materials decreases. Therefore, there is a possibility that the discharge capacity is low and the rate characteristics deteriorate.

An object of the present disclosure is to improve rate characteristics.

[1] A positive electrode active material, in which:
the positive electrode active material contains single crystal particles and polycrystalline particles;
the polycrystalline particles are formed by associating a plurality of the single crystal particles;
each of the single crystal particles and the polycrystalline particles contains a lithium nickel composite oxide having a layered structure; and
the single crystal particles satisfy all relationships of following formulas (1) to (3):

$$D 19 \leq 2.5 \qquad ( 1 )$$

$$D 50 \leq 5. \qquad ( 2 )$$

$$( D 90 - D 10 ) / D 50 \geq 3. . \qquad ( 3 )$$

In the formulas (1) to (3), D10, D50, and D90 each represent a particle diameter having an integrated value of 10%, a particle diameter having an integrated value of 50%, and a particle diameter having an integrated value of 90% in a volume-based particle size distribution of the single crystal particles. D10, D50, and D90 each have units of micrometers.

Single crystal particles have a long lithium (Li) diffusion distance in the single crystal particles, and therefore the utilization rate of Li in the single crystal particles is low. Thus, it is expected that the utilization rate of Li is improved by reducing the particle diameter of the single crystal particles as indicated in (1) and (2) above.

The “(D90-D10)/D50” indicated in (3) above is also referred to as “span value” or the like, for example. The span value is an index of the extent of the particle size distribution. It is considered that the particle size distribution is sharper as the span value is smaller. Conventional positive electrode active materials of a single crystal particle type have a sharp particle size distribution, and therefore tend to have a low filling property. Thus, it is expected that the filling property is improved and the frequency of contact between the single crystal particles is increased by broadening the particle size distribution of the single crystal particles as indicated in (3) above. It is considered that the discharge capacity is improved and the rate characteristics are improved by the synergy of these.

[2] The positive electrode active material according to [1], in which the single crystal particles satisfy all relationships of following formulas (4) to (6):

$$0.1 \leq D 10 \qquad ( 4 )$$

$$1. \leq D 50 \qquad ( 5 )$$

$$12 \geq ( D 90 - D 10 ) / D 50. \qquad ( 6 )$$

[3] The positive electrode active material according to [1] or [2], in which the single crystal particles satisfy a relationship of a following formula (7):

$$3. 0 \leq D 90 / D 50 \leq 12 . \qquad ( 7 )$$

[4] The positive electrode active material according to any one of [1] to [3], in which:
the lithium nickel composite oxide has a composition represented by a general formula LiₓNiₐCo_{b}Mn_{c}O_{y}; and
relationships 0.1≤x≤1.5, 0.5≤a≤1.0, 0≤b≤0.3, 0≤c≤0.3, a+b+c=1.0, and 1.5≤y≤2.1 are satisfied.

[5] A lithium ion secondary battery including
the positive electrode active material according to any one of [1] to [4].

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart showing a method for producing a positive electrode active material according to the present embodiment;

FIG. 2 is a schematic diagram showing the lithium ion secondary battery of the present embodiment;

FIG. 3 is a schematic diagram showing a positive electrode of the present embodiment;

FIG. 4 is a table showing the production conditions and the evaluation results of the positive electrode active materials of No. 1 to 6 in the embodiment; and

FIG. 5 is a chart showing the analysis results of the positive electrode active materials of No. 1 to 6 and the evaluation results of the evaluation cells in the embodiment.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

In this specification, when a compound is represented by a stoichiometric composition formula such as, for example, “LiCoO₂”, the stoichiometric composition formula is exemplary only. For example, when lithium cobalt oxide is expressed as “LiCoO₂”, unless otherwise specified, the lithium cobalt oxide is not limited to a composition ratio of “Li/Co/O=1/1/2”, and can include Li, Co and O in any composition ratio. The composition ratio may be non-stoichiometric.

In the present specification, at least one of the single crystal particles and the polycrystalline particles may be collectively referred to as a “positive electrode active material”. A “single crystal particle” refers to a particle that is a separate particle that is not agglomerated, consists essentially of a single particle, and whose grain boundaries are not visible in Scanning Electron Microscopy (scanning electron microscope, SEM) images. A “polycrystalline particle” refers to a particle formed by association (aggregation) of a plurality of single crystal particles.

In the context of “particle size distribution” herein, “D10”, “D50” and “D90” are defined as follows. D10 indicates the particle size in which the cumulative frequency from the smaller particle size becomes 10% in the volume-based particle size distribution. D50 indicates the particle size in which the cumulative frequency from the smaller particle size becomes 50% in the volume-based particle size distribution. D90 indicates the particle size in which the cumulative frequency from the smaller particle size becomes 90% in the volume-based particle size distribution. D10, D50 and D90 each have units of micrometers.

Herein, the volume-based particle size distribution can be measured by a laser diffraction particle size distribution measuring apparatus. The measurement procedure may be as follows. A measurement target (positive electrode active material) is prepared. A measurement sample (particle dispersion liquid) is prepared by mixing a measurement target and a dispersion medium. The measurement sample is introduced into a laser diffraction type particle size distribution measuring apparatus, whereby a volume-based particle size distribution is measured.

### Positive Electrode Active Material

The positive electrode active material of the present embodiment can absorb and release lithium ions reversibly. The positive electrode active material includes single crystal particles and polycrystalline particles. The polycrystalline particles are formed by associating a plurality of single crystal particles. Each of the single crystal particles and the polycrystalline particles includes a lithium nickel composite oxide having a layered structure. Each of the single crystal particles and the polycrystalline particles may be a positive electrode active material formed of a lithium nickel composite oxide having a layered structure. The lithium nickel composite oxide may be, for example, at least one selected from the group consisting of LiNiO₂, Li(NiCoMn)O₂, and Li(NiCoAl)O₂. Among them, Li(NiCoMn)O₂ is preferable because the resistive property is particularly excellent. The lithium nickel composite oxide preferably has a composition represented by the following general formula. In the present embodiment, the compositions of the single crystal particles and the polycrystalline particles are the same. The chemical composition of the positive electrode active material can be identified by, for example, high-frequency inductively coupled plasma-emission spectroscopy (Inductively Coupled Plasma Atomic Emission Spectroscopy, ICP-AES).

LiₓNiₐCo_{b}Mn_{c}O_{y}

In the above formula, relationships 0.1≤x≤1.5, 0.5≤a≤1.0, 0≤b≤0.3, 0≤c≤0.3, a+b+c=1.0, and 1.5≤y≤2.1 are satisfied.

### Single Crystal Particle

The single crystal particles are so-called small particles. Single crystal particles have a relatively small particle size compared to polycrystalline particles. Single crystal particles may form conductive paths between the polycrystalline particles. The single crystal particles have a volume-based particle size distribution. The single crystal particles satisfy all the relationships of the following formulas (1) to (3).

$$D 10 \leq 2.5 \qquad ( 1 )$$

$$D 50 \leq 5. \qquad ( 2 )$$

$$( D 90 - D 10 ) / D 50 \geq 3. \qquad ( 3 )$$

The single crystal particles have a long Li diffusivity in the single crystal particles, and thus the utilization rate of Li in the single crystal particles is low. Therefore, as shown in (1) and (2), by reducing the particle diameter of the single crystal particles, it is expected to improve the utilization rate of Li.

Further, the conventional single crystal particle type positive electrode active material has a sharp particle size distribution, and therefore tends to have a low filling property. Therefore, as shown in (3) above, it is expected that by broadening the particle size distribution of the single crystal particles, the filling property is improved and the contact frequency between the single crystal particles is increased. It is considered that the discharge capacity is improved and the rate characteristics are improved by these synergistic effects.

The single crystal particles may satisfy all the relationships of the following formulas (4) to (6).

$$0.1 \leq D 10 \qquad ( 4 )$$

$$1. \leq D 50 \qquad ( 5 )$$

$$12 \geq ( D 90 - D 10 ) / D 50 \qquad ( 6 )$$

D10 may be, for example, 0.2 μm or more, or 0.3 μm or more. D10 may be, for example, 2.0 μm or less, or 1.5 μm or less.

D50 may be, for example, 1.2 μm or more, or 1.5 μm or more. D50 may be, for example, 4.5 μm or less, or 4.0 μm or less.

D90 may be, for example, 7.0 μm or more, or 10 μm or more. D90 may be, for example, 30 μm or less, or 28 μm or less.

(D90−D10)/D50 may be, for example, 3.5 or more, or 4.0 or more. (D90−D10) The/D50 may be, for example, 11.5 or less, or 11 or less.

The single crystal particles may satisfy the relationship of the following formula (7).

$$3. 0 \leq D 90 / D 50 \leq 12 \qquad ( 7 )$$

D90/D50 may be, for example, 3.2 or more, or 3.5 or more. D90/D50 may be, for example, 11.5 or less, or 11 or less.

The single crystal particles may satisfy the relationship of the following formula (8).

$$1. 0 \leq D 50 / D 10 \leq 6.0 \qquad ( 8 )$$

D50/D10 may be, for example, 1.5 or more, or 1.8 or more. D50/D10 may be, for example, 5.5 or less, or 5.0 or less.

The single crystal particles may satisfy the relationship of the following formula (9).

$$1. 8 \leq D 90 / ( D 10 + D 50 ) \leq 10 \qquad ( 9 )$$

D90/(D10+D50) may be, for example, 2.0 or more, or 2.3 or more. D90/(D10+D50) may be, for example, 9.5 or less, or 9.0 or less.

### Polycrystalline Particles

The polycrystalline particles are so-called large particles. The polycrystalline particles have a relatively large particle size compared to the single crystal particles. The polycrystalline particles have a volume-based particle size distribution. D50 of the polycrystalline particles may be, for example, 5 μm or more and 20 μm or less.

The polycrystalline particles in the present embodiment are formed by associating a plurality of single crystal particles, and are different from conventional polycrystalline particles formed by aggregating single crystal particles. Both of them can be distinguished by, for example, the largest Feret diameter, the aspect ratio, or the like of the single crystal particles confirmed from SEM images. For example, the single crystal particles included in the polycrystalline particles in the present embodiment may have a maximum Feret diameter equivalent to that of the single crystal particles present alone. On the other hand, it is considered that the single crystal particles included in the conventional polycrystalline particles may have a maximum Feret diameter smaller than that of the single crystal particles present alone. The “maximum Feret diameter” indicates the distance between the two farthest points on the contour line of the particle.

### Content Ratio

The content ratio of the single crystal particles and the polycrystalline particles in the positive electrode active material is not particularly limited. These mass ratios (single crystal particles: polycrystalline particles) may be, for example, 10:90 to 90:10, 20:80 to 80:20, 30:70 to 70:30, or 40:60 to 60:40. The positive electrode active material may be composed only of single crystal particles and polycrystalline particles.

The positive electrode active material in the present embodiment is different from a conventional positive electrode active material in which single crystal particles and polycrystalline particles are mixed. Both can be determined, for example, by the largest Feret diameter of the single crystal particles identified from SEM images. For example, the average value of the maximum Feret diameters of the single crystal particles included in the polycrystalline particles and the average value of the maximum Feret diameters of the single crystal particles present alone fall within a range within +10%. On the other hand, in the conventional positive electrode active material, it is considered that the maximum Feret diameter of the single crystal particles contained in the polycrystalline particles and the single crystal particles present alone does not fall within the above range.

### Other

The positive electrode active material may contain an active material other than the above-described single crystal particles and polycrystalline particles within a range not impairing the object of the present embodiment. The other active material may be single crystal particles or polycrystalline particles.

### A Method for Producing a Positive Electrode Active Material, the Method Comprising:

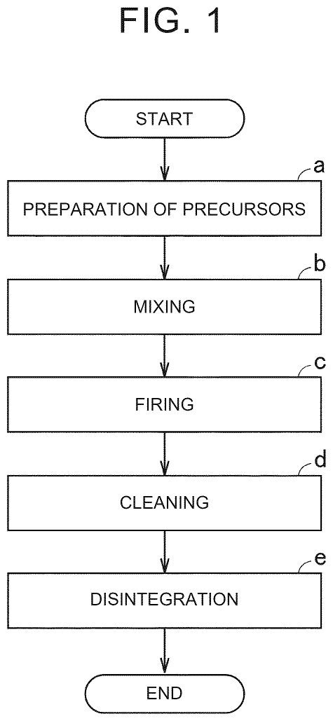

FIG. 1 is a schematic flowchart of a method for producing a positive electrode active material according to the present embodiment. Hereinafter, a method for producing a positive electrode active material according to the present embodiment may be abbreviated as a “bookbinding method”. The process includes “(a) preparation of precursors,” “(b) mixing,” “(c) calcination,” “(d) washing,” and “(e) crushing.”

### (a) Preparation of Precursors

The process includes providing a precursor. The precursor may include, for example, a metal hydroxide. The metal hydroxide may be synthesized, for example, by a coprecipitation method or the like. For example, a sulfate salt may be provided. Sulfate may include, for example, at least one selected from the group consisting of NiSO₄, CoSO₄, MnSO₄, and Al₂(SO₄)₃. By dissolving the sulfate in water, a raw material solution is prepared. The concentration of the raw material solution may be, for example, 10 to 50% by mass fraction. By dropping the raw material solution into the alkaline aqueous solution, precipitation of the metal hydroxide can be generated. For example, the precipitate (metal hydroxide) may be washed with water. After washing with water, the metal hydroxide may be recovered by filtration. After filtration, the metal hydroxide may be dried.

After the precipitation reaction is completed, the metal hydroxide may be calcined. By performing the preliminary calcination, dehydration of the metal hydroxide, removal of impurities, and the like can be performed. In the present process, any firing apparatus or furnace may be used. For example, muffle furnaces, electric furnaces, etc. may be used. The calcination may be carried out, for example, under an oxygen atmosphere.

The temperature of the preliminary firing may be, for example, 120° C. or higher, or 150° C. or higher. The temperature of the preliminary firing may be, for example, 220° C. or less, or 200° C. or less. The pre-baking time may be, for example, 4 hours or more, or 6 hours or more. The pre-baking time may be, for example, 10 hours or less, or 8 hours or less. The preliminary firing may be performed, for example, at a 0.2 MPa or higher, or at a 0.5 MPa or higher. The preliminary calcination may be performed, for example, at a 1.0 MPa or lower or 0.8 MPa or lower.

### (b) Mixing

The process includes mixing a precursor and a lithium compound to form a mixture. For example, grinding and mixing may be performed in a mortar or the like. Lithium-compounds are compounds containing Li. The lithium compound may include, for example, at least one selected from the group consisting of LiOH, and Li₂CO₃. The lithium compound is the lithium source of the lithium nickel composite oxide. The ratio of the amount of Li material to the amount of metallic hydroxide material may be, for example, greater than 1.2, greater than or equal to 1.3, greater than or equal to 1.5, greater than or equal to 1.75, or greater than or equal to 2.0. The ratio may be, for example, 4.0 or less, 3.5 or less, or 3.0 or less.

### (c) Firing

The method includes synthesizing a lithium nickel composite oxide by subjecting the mixture to calcination (hereinafter, also referred to as “main calcination”). The same firing apparatus and firing furnace as the preliminary firing may be used. The calcination may be carried out, for example, under an oxygen atmosphere.

The temperature of the main firing may be, for example, 650° C. or higher, or 700° C. or higher. The temperature of the main firing may be, for example, less than 850° C. or less than or equal to 800° C. The temperature of the main firing is higher than the temperature of the preliminary firing. The time for the main baking may be, for example, 8 hours or more, 9 hours or more, or 10 hours or more. The firing time may be, for example, 15 hours or less, 12 hours or less, or 10 hours or less. The time of the main firing is longer than the time of the preliminary firing.

### (d) Cleaning

The process includes cleaning the lithium nickel composite oxide. For example, the lithium nickel composite oxide may be washed with water. For example, the lithium nickel composite oxide may be crushed and then washed in a mortar or the like. After washing with water, the lithium nickel composite oxide may be filtered and dried.

### (e) Disintegration

The process includes crushing a lithium nickel composite oxide. Any grinder (e.g., mortar, lab mill, etc.) can be used. The particle size of the lithium nickel composite oxide can be adjusted by crushing.

### A Lithium Ion Secondary Battery Comprising

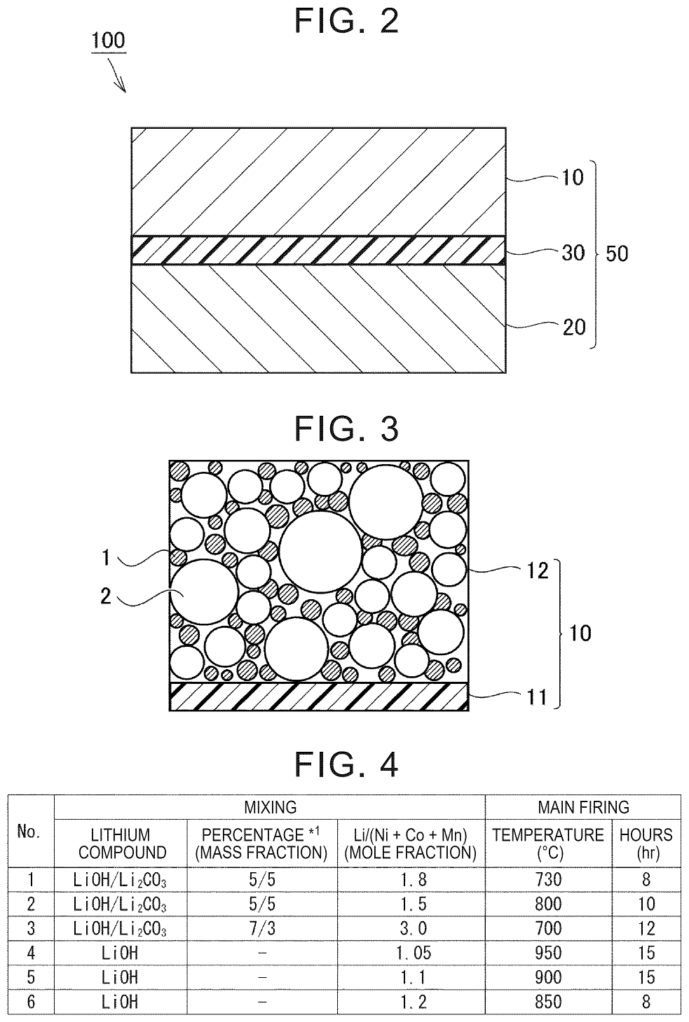

FIG. 2 is a schematic diagram showing a lithium ion secondary battery (hereinafter, may be abbreviated as “battery”) according to the present embodiment. The battery 100 includes a power generation element 50 and an electrolyte (not shown). The battery 100 may include an exterior body. The exterior body may house the power generation element 50 and the electrolyte. The outer casing may be, for example, a metallic case or a pouch made of Al laminated films.

The power generation element 50 may have any form. The power generation element 50 may be, for example, a wound type, a stacked type, or the like. The power generation element 50 may have a monopolar structure or a bipolar structure. The power generation element 50 includes a positive electrode 10, a negative electrode 20, and a separator 30. The separator 30 is disposed between the positive electrode 10 and the negative electrode 20. The electrolyte solution permeates the gap between the respective members and the gap in the respective members. Each member may be, for example, a sheet-like member.

### Positive Electrode

The positive electrode 10 includes a positive electrode active material. That is, the battery 100 includes a positive electrode active material. For example, the positive electrode 10 may include a positive electrode current collector 11 and a positive electrode active material layer 12. The positive electrode current collector 11 supports the positive electrode active material layer 12. The positive electrode current collector 11 may include, for example, an Al foil.

FIG. 3 is a schematic diagram showing the positive electrode of the present embodiment. The positive electrode active material layer 12 includes a positive electrode active material. The positive electrode active material includes single crystal particles 1 and polycrystalline particles 2. The details of the single crystal particles 1 and the polycrystalline particles 2 are as described above.

The positive electrode active material layer 12 may further include, for example, a conductive material, a binder, and the like. The conductive material may include, for example, acetylene black (AB). The binder may include, for example, PVDF or the like. The conductive material and the binder may be, for example, 0.1 mass % or more and 10 mass % or less with respect to the positive electrode active material layer 12.

### An Anode, Comprising:

The negative electrode 20 may include a negative electrode current collector and a negative electrode active material layer. The negative electrode current collector may include, for example, a copper (Cu) foil. The anode active material layer includes an anode active material. The negative electrode active material may include, for example, at least one selected from the group consisting of graphite, soft carbon, and hard carbon. The negative electrode active material layer may further include, for example, a conductive material, a binder, and the like.

The conductive material may include, for example, a carbon nanotube (CNT) or the like. The binder may include, for example, carboxymethylcellulose (CMC), styrene-butadiene rubber (SBR), and the like. The blending amount of the conductive material and the binder may be, for example, 0.1 to 10 parts by mass with respect to 100 parts by mass of the negative electrode active material.

### Separator

The separator 30 is porous. The separator 30 may pass through the electrolytic solution. The separator 30 separates the positive electrode 10 and the negative electrode 20 from each other. The separator 30 is electrically insulating. The separator 30 may include, for example, a polyolefin-based resin such as polyethylene (PE) or polypropylene (PP). The separator 30 may have, for example, a single-layer structure or a multi-layer structure. The separators 30 may consist of, for example, substantially PE layers, and may be formed by laminating PP layers, PE layers, and PP layers in this order. For example, a heat-resistant layer may be formed on the surface of the separator 30.

### Electrolytic Solution

The electrolyte solution includes solvents and Li salts. The solvent is aprotic. The solvent may comprise any component. The solvents may include, for example, at least one selected from the group consisting of ethylene carbonate (EC), dimethyl carbonate (DMC), and ethyl methyl carbonate (EMC).

Li salt is a supporting electrolyte. Li salt is dissolved in a solvent. Li salt may include, for example, at least one selected from the group consisting of LiPF₆ and LiBF₄. Li salt may have a molar concentration of, for example, 0.5 mol/L or more and 2.0 mol/L or less.

The electrolyte solution may further contain an optional additive. The electrolytic solution may contain, for example, 0.01% by mass or more and 5% by mass or less of an additive. The additive may include, for example, at least one selected from the group consisting of vinylene carbonate (VC), vinyl ethylene carbonate (VEC), and the like. Note that a solid electrolyte may be used instead of the electrolytic solution.

### Production of Positive Electrode Active Material

### No. 1 to No. 6

The raw material solutions were formed by dissolving NiSO₄, CoSO₄, MnSO₄ in ion-exchanged water. In the feed solutions, the molar fraction of Ni, Co, Mn was “Ni/Co/Mn=18/1/1”. The concentration of the raw material solution was 0.2 mol %.

Ammonia water was placed in the reaction vessel. The inside of the reaction vessel was replaced with nitrogen while the ammonia water was stirred by the stirrer. Further, the reaction solution was formed by charging NaOH into the reaction vessel. Precipitation (metallic hydroxide) was formed by dropping the raw material solution and ammonia-water into the reaction liquid so that the reaction liquid maintained a certain pH.

In the muffle furnace, the metal hydroxide was calcined. Temperature of the preliminary firing is 120° C., the time of the preliminary firing is 5 hours, the pressure of the preliminary firing was 0.3 MPa. After the preliminary calcination, the metal hydroxide was dispersed in ion-exchanged water to form a dispersion. The dispersion was sufficiently stirred by the spatula. That is, the metal hydroxide was washed with water. After washing with water, the metal hydroxide was collected by filtration. The metal hydroxide was dried at 110° C. for 12 hours to form a dry matter.

In the mortar, the dry matter and the lithium compound were mixed to form a mixture. The lithium compound used and its mass fraction are as shown in FIG. 4. The proportions of the amounts of Li to the amounts of metallic hydroxides (Ni, Co and Mn) are as shown in FIG. 4.

In the muffle furnace, the mixture was subjected to main calcination to synthesize a lithium nickel composite oxide (positive electrode active material). Conditions for this firing are as shown in FIG. 4.

In the mortar, the lithium nickel composite oxide was disintegrated. After crushing, the lithium nickel composite oxide was dispersed in pure water to form a dispersion. The dispersion was thoroughly stirred (washed with water) by the spatula. After washing with water, the lithium nickel composite oxide was collected by filtration. The lithium nickel composite oxide was rinsed with pure water. After rinsing, the lithium nickel composite oxide was vacuum dried at 90° C.

After vacuum drying, the particle size of the lithium nickel composite oxide was adjusted by a mortar.

### Analysis

An ICP emission spectrometer (PS3520UVDD, manufactured by Hitachi High-Tech Science Co., Ltd.) was used to confirm the composition of the positive electrode active materials of the respective No. . . . It was confirmed that all the positive electrode active materials were composed of “LiNi_{0.90}Co_{0.05}Mn_{0.05}O₂”. In addition, the crystal structure of the respective No. was confirmed to have a layered crystal structure in any of the positive electrode active materials.

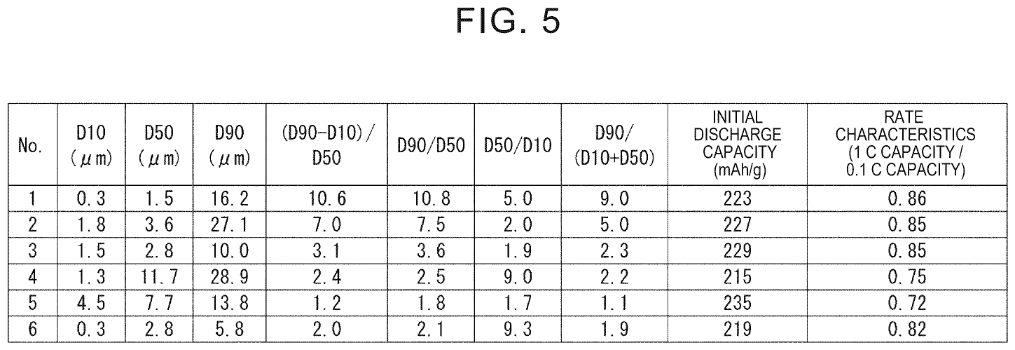

The volume-based particle size distribution of the single crystal particles of the respective No. was measured by a laser-diffraction-type particle size distribution measuring device (WingSALD-2300, Shimadzu Corporation). The particle size distribution of the single crystal particles of the respective No. is shown in FIG. 5.

### Evaluation

### Manufacture of Evaluation Cells

A cylindrical lithium ion secondary battery (evaluation cell) was manufactured. The configuration of the evaluation cell is as follows.
Power generation element: wound type
Positive electrode: positive electrode active material/AB/PVDF=88/10/2 (mass-ratio)
Negative electrode: negative electrode active material (natural graphite), CMC, SBR
Electrolyte: LiPF₆ (1 mol/L), EC/DMC/EMC=3/4/3 (volume)

The positive electrode and the negative electrode were manufactured by coating a slurry on the surface of a substrate (metal foil). As a coating apparatus, a film applicator (with a film thickness adjustment function) manufactured by All Good Co. was used. After coating the slurry, the coating was dried at 80° C. for 5 minutes.

### Initial Discharge Capacity

Charging and discharging were carried out in the range of 3.0 to 4.1 V with a constant current of 0.1 C at 25° C., and the capacity at the time of discharging was measured as the initial discharge capacity. The effect is shown in FIG. 5. Note that “C” is a symbol indicating a rate. At 1 C rates, the rated capacity is flowed over an hour.

### Rate Characteristics

The rate of 0.1 C and the rate of 1 C were measured at 25° C. to determine the discharge capacity of the evaluation cell. The “1 C discharge capacity/0.1 C discharge capacity” was obtained by dividing the discharge capacity (1 C discharge capacity) at the rate of 1 C by the discharge capacity (0.1 C discharge capacity) at the rate of 0.1 C. The higher the “1 C discharge capacity/0.1 C discharge capacity”. the better the rate-characteristics.

### Results

As shown in FIG. 5. when the conditions of the present disclosure are satisfied, the rate characteristics tend to improve.

What is claimed is:

1. A positive electrode active material, wherein:
the positive electrode active material contains single crystal particles and polycrystalline particles;
the polycrystalline particles are formed by associating a plurality of the single crystal particles;
each of the single crystal particles and the polycrystalline particles contains a lithium nickel composite oxide having a layered structure; and
the single crystal particles satisfy all relationships of following formulas (1) to (3):
$$D 10 \leq 2.5 \qquad ( 1 )$$
$$D 50 \leq 5. \qquad ( 2 )$$
$$( D 90 - D 10 ) / D 50 \geq 3. \qquad ( 3 )$$
in the formulas (1) to (3), D10, D50, and D90 each represent a particle diameter having an integrated value of 10%, a particle diameter having an integrated value of 50%, and a particle diameter having an integrated value of 90% in a volume-based particle size distribution of the single crystal particles, and D10, D50, and D90 each have units of micrometers.

2. The positive electrode active material according to claim 1, wherein the single crystal particles satisfy all relationships of following formulas (4) to (6):
$$0.1 \leq D 10 \qquad ( 4 )$$
$$1. \leq D 50 \qquad ( 5 )$$
$$12 \geq ( D 90 - D 10 ) / D 50 . \qquad ( 6 )$$

3. The positive electrode active material according to claim 1, wherein the single crystal particles satisfy a relationship of a following formula (7):
$$3. 0 \leq D 90 / D 50 \leq 12 . \qquad ( 7 )$$

4. The positive electrode active material according to claim 1, wherein:
the lithium nickel composite oxide has a composition represented by a general formula LiₓNiₐCo_{b}Mn_{c}O_{y}; and
relationships 0.1≤x≤1.5, 0.5≤a≤1.0, 0≤b≤0.3, 0≤c≤0.3, a+b+c=1.0, and 1.5≤y≤2.1 are satisfied.

5. A lithium ion secondary battery comprising the positive electrode active material according to claim 1.
